(19) United States
(12) Patent Application Publication
(10) Pub. No.: US 2007/0067157 A1
(43) Pub. Date: Mar. 22, 2007

(54) System and method for automatically extracting interesting phrases in a large dynamic corpus

(75) Inventors: Vinay Kumar Kaku, Fremont, CA (US); Keiko Kurita, Los Gatos, CA (US); Carlton Wayne Niblack, San Jose, CA (US); Jasmine Gina Novak, Mountain View, CA (US); Zengyan Zhang, San Jose, CA (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/234,667

(22) Filed: Sep. 22, 2005

(51) Int. Cl. G06F 17/21

(52) U.S. Cl. 704/10

(57) ABSTRACT

A phrase extraction system combines a dictionary method, a statistical/heuristic approach, and a set of pruning steps to extract frequently occurring and interesting phrases from a corpus. The system finds the “top k” phrases in a corpus, where k is an adjustable parameter. For a time-varying corpus, the system uses historical statistics to extract new and increasingly frequent phrases. The system finds interesting phrases that occur near a set of user-designated phrases. The system uses these designated phrases as anchor phrases to identify phrases that occur near the anchor phrases. The system finds frequently occurring and interesting phrases in a time-varying corpus is changing in time, as in finding frequent phrases in an on-going, long term document feed or continuous, regular web crawl.

### FIELD OF THE INVENTION

The present invention generally relates to text classification. More specifically, the present invention relates to locating, identifying, and selecting phrases in a text that are of interest as defined by frequency of occurrence or by a set of predefined terms or topics.

### BACKGROUND OF THE INVENTION

The Internet has provided an explosion of electronic text available to users. Increasingly, automatic text analysis is used to identify key terms within text so that users can identify frequently occurring phrases in a corpus such as the WWW. Furthermore, users such as businesses or companies are increasingly analyzing large document sets such as those available on the Internet, in news feeds, or in weblogs to identify trends and monitor public reaction to products, company image, or events involving the company.

Automatic extraction of interesting phrases can provide phrases useful in a variety of text analysis functions such as feature selection for clustering/classification, computing document similarity, information retrieval, and extracting emerging associations of subjects/entities. Conventional approaches for automatic phrase extraction comprise a dictionary approach, a linguistic approach, and a statistical approach. Although these automatic phrase extraction techniques have proven to be useful, it would be desirable to present additional improvements.

The dictionary approach to automatic phrase extraction uses a known, specified dictionary or list of phrases to identify occurrences of each of these phrases in each input document. This approach is easy to implement and requires relatively few computational resources. However, results are limited by the comprehensiveness of the dictionary. Terms and phrases not included in the dictionary, although interesting, are not counted. The restrictions of the dictionary approach are most obvious when applied to a constantly changing corpus such as the WWW in which new terms are introduced continually. A static dictionary used by the dictionary approach is unable to adapt to a dynamic corpus. The dictionary approach cannot find new, emerging terms in a dynamic corpus.

The linguist approach uses natural language processing in the form of a part-of-speech tagger and parser to extract phrases from a corpus. Extracted phrases are counted to determine frequency of occurrence. The linguistic approach achieves good precision for English and can analyze a dynamic corpus. However, this approach is language dependent. Specific phrase types (noun phrases, adjective phrases, etc.) are selected for identification. These selected phrase types may omit frequently occurring and interesting phrases. System implementation of this approach requires a relatively large amount of computational resources for reliable part-of-speech taggers. The required computational resources of this approach limits applicability, and is difficult to apply to a large corpus or a corpus comprising an incoming stream of documents.

The statistical approach counts the frequency of occurrence and related statistics of each possible phrase and selects the most frequently occurring phrases. This approach learns the statistical phrase information from the corpus and identifies frequently occurring and interesting phrases based on these statistics. But in a naive application, the statistical approach cannot extract valid phrases that do not occur frequently enough. Consequently, the statistical approach extracts inaccurate, partial extractions.

What is therefore needed is a system, a computer program product, and an associated method for automatically extracting interesting phrases in a large dynamic corpus. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for automatically extracting interesting phrases in a large dynamic corpus. The present system combines a dictionary method, a statistical/heuristic approach, and a set of pruning steps to extract frequently occurring and interesting phrases from a corpus such as, for example, a collection of documents. The present system finds the “top k” phrases in a corpus, where k is an adjustable parameter. For a large corpus, an exemplary range for k, for example, is 200 to 1000. For a time-varying corpus or collection of documents, the present system uses historical statistics to extract new and increasingly frequent phrases. The present system can extract interesting phrases in any language that can be tokenized.

The present system further finds frequently occurring and interesting phrases that occur near a set of other terms or phrases. A user specifies a set of “anchor phrases”. The present system finds phrases that occur near the anchor phrases. In a typical business application, the set of frequently occurring phrases of interest are those that occur near designated phrases such as, for example, a given company, product, or person name. The present system uses these designated phrases as anchor phrases to identify phrases that occur near the anchor phrases. For example, a company may wish to find phrases that occur near a product name in a large collection of documents.

The present system finds frequently occurring and interesting phrases when the corpus is changing in time, as in finding frequent phrases in an on-going, long-term document feed or continuous, regular web crawl. In this case, the present system enables a user to find emerging or new phrases as they are introduced in the time-varying corpus. Furthermore, the present system allows a company, for example, to identify phrases associated with products in a “real-time” fashion. Consequently, the present system allows a company to analyze, for example, the effectiveness of an advertising campaign.

The present system comprises a tokenizer, a term spotter, a disambiguator, a token combiner, an N-token phrase counter, a pruner, a merger, a count adjustor, and a phrase selector. The tokenizer preprocesses each input document, generating tokens and expanding abbreviations. A token is a set of characters identified, for example, by white space separation in text.

If a set of “anchor phrases” is given around which the frequent phrases are to be found, the term spotter identifies the anchor phrases and the disambiguator optionally disambiguates references to the anchor phrases. An anchor phrase may be one or more tokens. For example, “ABC” and “Any Business Company” can be anchor phrases.

The token combiner uses a predefined dictionary or grammar rules to combine a set of tokens into a single compound token. For example, the token combiner applies rules based on capitalization to find and combine proper names. The token combiner further combines tokens that correspond to dictionary references into a single compound token treated as a single token. For example, the present system finds the term “sea shell”, references the dictionary, and identifies “sea shell” as a compound token instead of separate tokens in a phrase.

The N-token phrase counter considers every possible sequence of up to N consecutive tokens occurring in the text. Anchor phrases are treated as delimiters; sets of N consecutive tokens do not cross over them. Compound tokens identified by the token combiner can be used as delimiters or considered as one token. For each N-token phrase considered, the N-token phrase counter accumulates an occurrence count in an N-token phrase count, provided the considered N-token phrase satisfies certain constraints.

The pruner applies a threshold to eliminate infrequently occurring phrases. The merger merges overlapping phrases. The count adjustor adjusts N-token phrase counts to account for sub-phrases of N-token phrases, plurals, and possessives. The pruner identifies a set of selected phrases by applying thresholds to the N-token phrase counts, rejecting N-token phrases that occur infrequently or are too common to be of interest. For a time-varying corpus, the phrase selector applies thresholds to a frequency of occurrence relative to a historical frequency to obtain a set of selected phrases.

Different source groups, such as general news daily newspapers, general interest magazines, Web blogs and company-published Web sites, all have distinct wording, style, and grammatical structure. Applying the present system to each source produces a set of frequent phrases specific to that source. Source categories can also be defined by stakeholder groupings such as, for example, “local environmental non-governmental organizations in Northern California” that contains content from associated e-newsletters and Web sites. Marketing professionals responsible for tracking and managing marketing messages, issues, and plans can use the present system to identify phrases that frequently appear near company products or services.

The present system may be embodied in a utility program such as a phrase extraction utility program. The present system also provides means for the user to identify a corpus for analysis by the phrase extraction utility programs and parameters for use by the phrase extraction utility program. The parameters comprise a value for a number of tokens (N), also referred to as a phrase length parameter, in a selected phrase, and a number of phrases selected (k). The present system further provides means for the user to select a predefined dictionary or provide a customized dictionary. In one embodiment, the present system provides means for the user to specify a set of anchor phrases for analysis and a vicinity specification for analysis of text in proximity of the anchor phrases. In another embodiment, the present system provides means for the user to specify a maximum allowable memory consumption. The present system provides means for invoking the phrase extraction utility program to analyze the corpus and provide a set of k phrases ranked according to the count of occurrences.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a phrase extraction system of the present invention can be used;

FIG. 2 is a block diagram of the high-level architecture of the phrase extraction system of FIG. 1;

FIG. 4 is a process flow chart illustrating a method of the phrase extraction system of FIGS. 1 and 2;

FIG. 4 is a block diagram of a high-level architecture of an embodiment of the phrase selection system of FIG. 1 in which anchor phrases are identified and references to anchor phrases are analyzed;

FIG. 5 is comprised of FIGS. 5A and 5B, and represents a process flow chart illustrating a method of operation of the phrase extraction system of FIGS. 1 and 2 in identifying anchor phrases and analyzing references to anchor phrases.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Anchor Phrase: A phrase or word designated by a user as a basis of analysis of a corpus. Anchor phrases are identified in the corpus and phrases occurring within a predetermined vicinity of the anchor phrases are identified, analyzed, and selected according to predetermined criteria.

Interesting Phrase: A phrase with a sufficient occurrence count such that the phrase can be utilized to achieve an analysis goal for a corpus.

Non-interesting Phrase: A phrase with an occurrence count that is either too high or too low to be of interest in analyzing a corpus. A phrase with an occurrence count that is too high is too common for use. In web documents, a phrase with an occurrence count that is too high is, for example, “click here”.

N-token phrase: a phrase comprising N or fewer tokens, where N is a predetermined value, selected, for example, to optimize results with respect to computational resources required to obtain the results.

Phrase: One or more tokens in close proximity (or contiguous) that represent a specific meaning.

tfidf (Term Frequency Inverse Document Frequency): A statistical technique used to evaluate the importance a of token or N-token phrase in a document. Importance increases proportionally to the number of times a token or N-token phrase appears in the document. Importance is offset by how often the word occurs in all of the documents in the collection or corpus. The use of tfidf in conjunction with the present invention is novel. Typically, tfidf is used as a method to score documents in a collection, whereas tfidf is used herein to refer to a method for scoring tokens or phrases.

Token: a computer readable set of characters representing a single unit of information such as, for example, a word.

Weblog (blog): an example of a public board on which online discussion takes place.

Word: an object comprising characters isolated by analyzing a corpus. In the English language, for example, a word is an object separated by white spaces.

World Wide Web (WWW, also Web): An Internet client-server hypertext distributed information retrieval system.

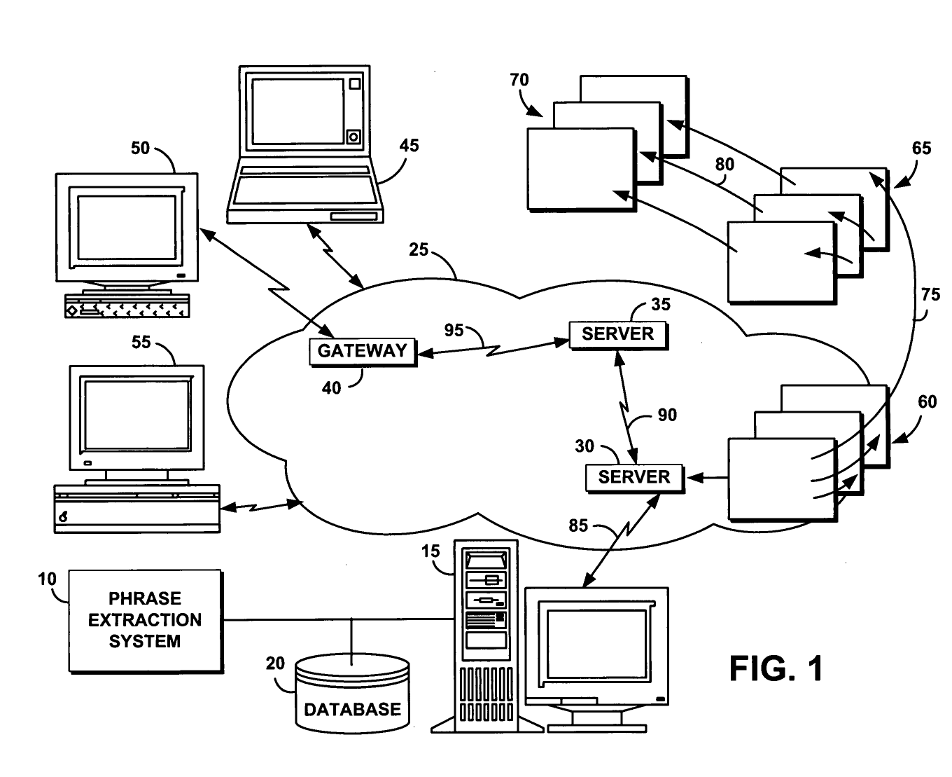

FIG. 1 portrays an exemplary overall environment in which a system, a service, a computer program product, and an associated method for automatically extracting interesting phrases in a large dynamic corpus (the “system 10”) according to the present invention may be used. System 10 includes a software or computer program product that is typically embedded within or installed on a host server 15. Alternatively, the system 10 can be saved on a suitable storage medium such as a diskette, a CD, a hard drive, or like devices. While the system 10 is described in connection with the World Wide Web (WWW), the system 10 may be used with a stand-alone database of documents such as dB 20 or other text sources that may have been derived from the WWW or other sources.

A cloud-like communication network 25 is comprised of communication lines and switches connecting servers such as servers 30, 35, to gateways such as gateway 40. The servers 30, 35 and the gateway 40 provide communication access to the Internet. Users, such as remote Internet users, are represented by a variety of computers such as computers 45, 50, 55. An exemplary corpus analyzed by system 10 is the WWW, generally represented by web documents 60, 65, 70. Web documents 60, 65, 70 typically comprise hypertext links to additional documents, as indicated by links 75, 80.

The host server 15 is connected to the network 25 via a communications link 85 such as a telephone, cable, or satellite link. The servers 30, 35 can be connected via high-speed Internet network lines 90, 95 to other computers and gateways.

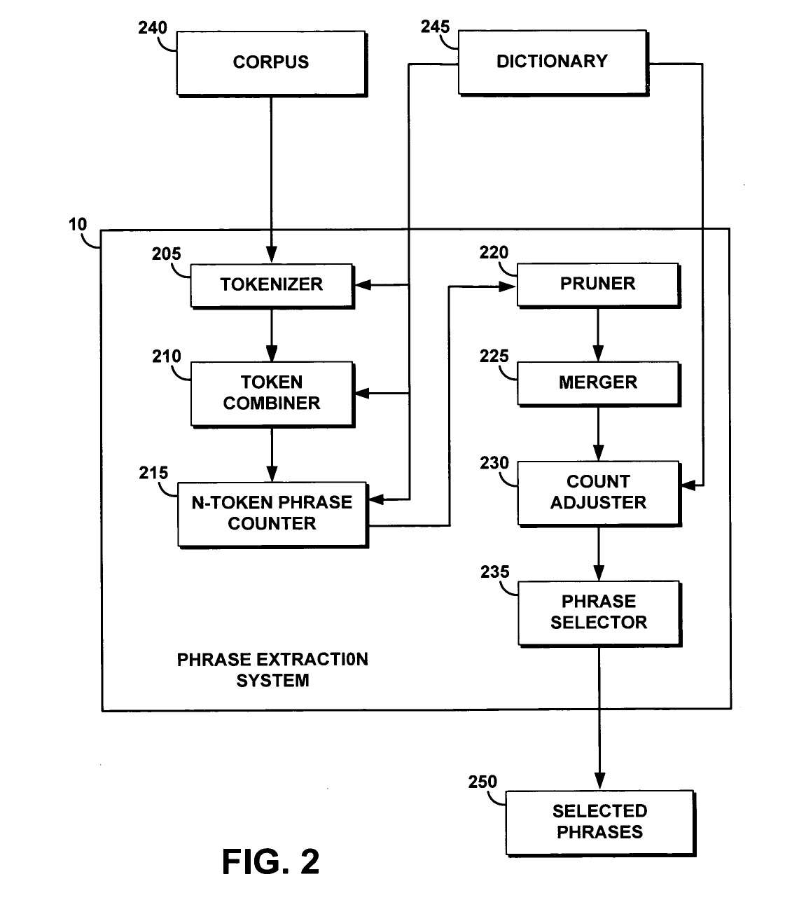

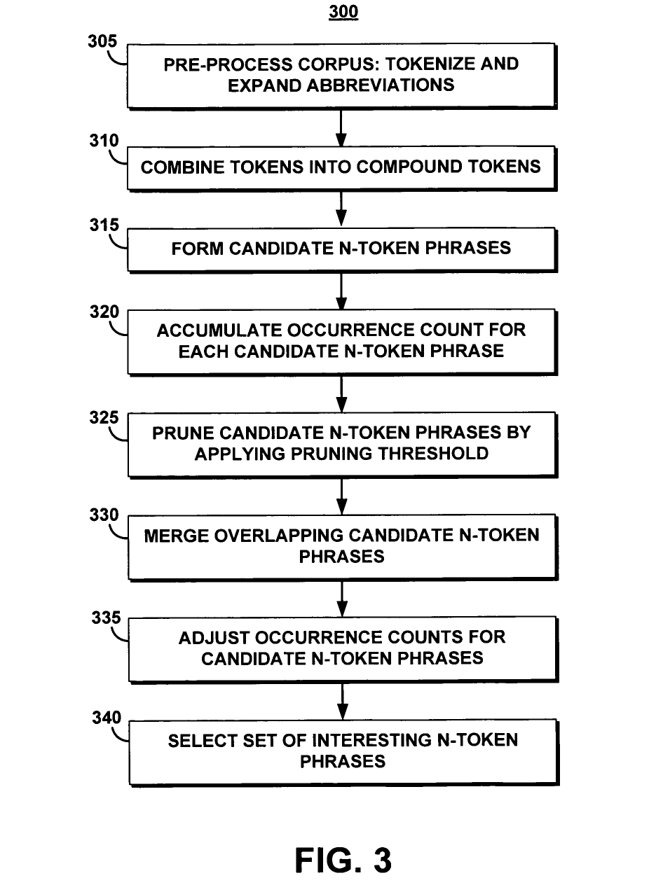

FIG. 2 illustrates a high-level hierarchy of system 10. System 10 comprises a tokenizer 205, a token combiner 210, an N-token phrase counter 215, a pruner 220, a merger 225, a count adjustor 235, and a phrase selector 235.

Input to system 10 is a corpus 240 comprising text in the form of, for example, documents, web pages, blogs, online discussions, etc. Corpus 240 comprises any language that can be tokenized. System 10 is capable of analyzing more than one language at a time in corpus 240, as long as the languages are properly tokenized.

Input to system 10 further comprises a dictionary 245. Dictionary 245 comprises a set of stop words, uninteresting or “noisy” phrases, compound phrases, compound tokens, expansions for abbreviations, and grammar rules. Stop words comprise articles such as “the”, prepositions such as “at, pronouns such as “he”, and other commonly used words that do not add meaning to a phrase. “Noisy” phrases comprise terms such as “copyrighted” or “all rights reserved” that are common on web pages. Compound phrases represent word groupings that are considered to represent a single word meaning. The compound tokens are associated with the compound phrases. In one embodiment, the compound tokens comprise two binary token attributes: use-as-single-token and use-as-delimiter.

Output of system 10 is a set of selected phrases 250, the k most interesting phrases ranked according to a count of occurrence in the corpus. For a corpus 240 that comprises time-varying content, the k most interesting phrases are ranked according to a frequency of occurrence relative to a historical frequency.

The tokenizer 205 preprocesses each input document, generating tokens and expanding abbreviations. A token is a set of characters identified, for example, by white space separation in text. The token combiner 210 uses input from dictionary 245 to combine a set of tokens into a single compound token. For example, the token combiner 210 applies rules based on capitalization to find and combine proper names. The token combiner 210 further combines tokens that correspond to references in dictionary 245 into a single compound token.

The N-token phrase counter 215 considers every possible sequence of up to N consecutive tokens occurring in the text. Anchor phrases are treated as delimiters; sets of consecutive tokens in a selected N-token phrase do not cross over the anchor phrase. System 10 determines phrases around, but not including, the anchor phrase. Compound tokens identified by the token combiner 210 can be used as delimiters or considered as one token. For each N-token phrase considered, the N-token phrase counter 215 accumulates an occurrence count in an N-token phrase count, provided the considered N-token phrase satisfies certain constraints.

The pruner 220 applies an initial threshold to eliminate infrequently occurring phrases and to dispose of apparent unlikely phrases. The merger 225 merges overlapping phrases. The count adjustor 235 adjusts N-token phrase counts to account for sub-phrases of N-token phrases, plurals, and possessives. The pruner 220 identifies a set of selected phrases by applying thresholds to the N-token phrase counts, rejecting N-token phrases with occurrence counts that are too low or too high to be of interest. The phrase selector 235 should just pick the top k phrases based on different criterion in different cases: adjusted counts in no-anchor static corpus (e.g., local counts or global counts) in with-anchor static corpus; c/Cn in time-varying no-anchor corpus; and f/fₙ in time-varying with-anchor corpus.

FIG. 3 illustrates a method 300 in generating a set of selected phrases 250 from a corpus 240 using dictionary 245 as input. System 10 preprocesses corpus 240 (step 305). Tokenizer 205 breaks the text of corpus 240 into tokens, and recognizes alternate spellings and expands any abbreviations according to information provided in dictionary 245. For example, tokenizer 205 recognizes alternate spellings for “Al Qaida” and expands Int'l to international and dept to department. An output of tokenizer 205 is a set of tokens.

From the predefined list of compound phrases in dictionary 245, the token combiner 210 identifies and combines tokens representing a compound phrase into a compound token (step 310). The token combiner 210 may also apply grammar rules from dictionary 245 to combine two or more tokens together, such as combining a string of capitalized words that represent an English proper name into a compound token. A compound token can comprise two or more tokens. Each compound token comprises compound token attributes that indicate how the compound token is to be accumulated in an N-token phrase. Compound token attributes comprise use-as-single-token and use-as-delimiter.

The N-token phrase counter 215 forms candidate N-token phrases (step 315). The N-token phrase counter 215 examines each sequence of tokens in the corpus 240, forming token sequences up to a length of N tokens. The parameter N is a parameter adjustable by a user. A typical value for N is, for example, 5. Within each token sequence, the N-token phrase counter 215 treats each compound token as directed by the associated compound token attribute. If the compound token attribute use-as-single-token is true, the N-token phrase counter 215 considers the compound token a single token. The compound token counts as one token in the N-token phrase. If the compound token attribute use-as-delimiter is true, the N-token phrase counter 215 considers the compound token as a delimiter and does not construct N-token phrases that comprise or cross over the compound token. The N-token phrase counter 215 does not form token sequences that cross sentence, paragraph, or other context boundaries such as, for example, table cells.

The N-token phrase counter 215 selects candidate N-token phrases from the token sequences. The N-token phrase counter 215 ignores stop words (from dictionary 245) that fall at the beginning or end of a candidate N-token phrase; consequently, candidate N-token phrases do not start or end with a stop word as defined in the stop words list in dictionary 240. Furthermore, the candidate N-token phrases do not start with a numeric token, eliminating uninteresting or noisy text strings such as tracking numbers and product codes. System 10 maintains a table entry in a candidate N-token phrase table for each candidate N-token phrase.

The N-token phrase counter 215 accumulates a count of the number of occurrences of each of the candidate N-token phrases as an occurrence count (step 320). In one embodiment, the N-token phrase counter 215 trims the number of candidate N-token phrases when a size of the candidate N-token phrase table grows to a predetermined maximum memory consumption. At this point, the N-token phrase counter 215 pauses processing of candidate N-token phrases and investigates a histogram of the occurrence counts. The N-token phrase counter 215 removes the most common and least common candidate N-token phrases by applying an interim most common threshold and an interim least common threshold, collectively referenced as interim thresholds.

The interim thresholds are determined as a percentage of the sum of occurrence counts for some or all of the candidate N-token phrases. For example, the least common threshold may be 5% and the most common threshold may be 2%. In this manner, the N-token phrase counter 215 continually identifies candidate N-token phrases and accumulates counts for the candidate N-token phrases while discarding candidate N-token phrases that do not meet criteria for designation as N-token phrases. The N-token phrase counter 215 then resumes processing candidate N-token phrases.

As an example of memory usage of the candidate N-token phrase table, an average size of a candidate N-token phrase is approximately 20 bytes. System 10 requires approximately an additional 10 bytes for counts, hash, and collision links. In this example, 30 million candidate N-token phrases require approximately 1 GB of memory.

In one embodiment, system 10 writes the candidate N-token phrase table to disk as a partial dump. When corpus 240 has been processed, system 10 merges the partial dumps.

When corpus 240 has been processed, pruner 220 applies a pruning threshold to the occurrence counts, favoring longer phrases (step 325). Pruner 220 selects the candidate N-token phrases with occurrence counts that exceed the pruning threshold. To favor longer phrases, the pruning threshold is as follows:

$$( 1 + \frac{b * L ( p )}{N} ) * c ( p )$$

where L(p) is a length of the candidate N-token phrase in number of tokens, c(p) is the occurrence count, N is the maximum phrase length, and b is an adjustable phrase length parameter. An exemplary value for b is 0.25. Larger values of b favor longer phrases.

The pruner 220 computes an ordered histogram of the occurrence counts. The pruner 220 excludes candidate N-token phrases with occurrence counts that occur in a top T percent or a bottom t percent of the ordered histogram. An exemplary value for T is 5%; an exemplary value for t is 30%. Excluding the top T % excludes common and uninteresting phrases such as “click here”. Excluding the bottom t % phrases excludes infrequent phrases.

The merger 225 merges candidate N-token phrases with similar tokens into longer candidate phrases (step 330). The value for N determines the longest phrase (measured in tokens) for which system 10 accumulates counts and, consequently, the longest phrase that system 10 identifies. Interesting phrases may be longer than N tokens; however, increasing the value of N to detect these longer phrases requires additional computational resources and memory.

For example, system 10 analyzes the following text sentence:

“Use this product only as directed”

System 10 generates the following candidate N-token phrases, where N=5 and stop words are allowed:

Use this product only as this product only as directed

The merger 225, for an identified phrase P₁ of length N, determines if a phrase P₂ of length N starting with the preceding (N−1) tokens of phrase P₁ exists with the same N-token phrase count in the candidate N-token phrase table. If such a phrase P₂ exists, merger 225 merges P₁ and P₂ into a single longer phrase. In the example above, the merger 225 merges the phrases into the following phrase:

Use this product only as directed.

The count adjuster 230 adjusts counts for candidate N-token phrases that are sub-phrases or that comprise a plural or a possessive, generating an adjusted count for candidate N-token phrases (step 335). For any candidate N-token phrase longer than one token, the count adjuster 230 subtracts the occurrence count from associated sub-phrases. For example, system 10 identifies candidate N-token phrases as “frequent flyer miles” with an occurrence count of 25 and “frequent flyer” with an occurrence count of 125. The occurrence count for “frequent flyer miles” is subtracted from the occurrence count for “frequent flyer”, yielding an occurrence count of 100 for “frequent flyer”.

The count adjuster 230 further combines the occurrence counts for candidate N-token phrases comprising a plural or a possessive, according to grammar rules in dictionary 245. For example, the count adjustor 230 combines the occurrence count for “company policy” with the occurrence count for “company's policy”. Similarly, the count adjustor 230 combines the occurrence count for “company policy” with the occurrence count for “company policies”.

The phrase selector 235 orders the candidate N-token phrases according to adjusted occurrence count. The phrase selector 235 selects for output as selected phrases 250 those candidate N-token phrases with the k highest values of adjusted occurrence count (step 340).

In one embodiment, system 10 analyzes a time-varying corpus such as an on-going web crawl in which new or modified documents are available on a continual basis. The phrase selector 235 computes a threshold for selecting those candidate N-token phrases with the k highest relative occurrences by looking at a history of the candidate N-token phrases. The occurrence counts (referenced as c over a time interval t) are accumulated as new documents arrive in the time-varying corpus. The phrase selector 235 computes cₙ, an average of the candidate N-token counts, c, over the preceding n time intervals. If cₙ=0, the phrase selector 235 flags the candidate N-token phrase as a new phrase. If cₙ≠0, the phrase selector 235 computes a relative count as c/cₙ. The phrase selector 235 selects as selected phrases 250 those candidate N-token phrases with the k highest values of c/cₙ. The number of candidate N-token phrases obtained is [k+(number of new phrases)], where the new phrases are selected as described herein.

In one embodiment, System 10 maintains historical counts to use in processing candidate N-token phrases in a time-varying corpus. Each time a candidate N-token phrase is processed, system 10 saves the current value for f/fₙ for all applicable candidate N-token phrases for use in future computations. Previously saved values for f/fₙ are discarded after n intervals where fₙ is the average of counts for the phrase over the last n time intervals.

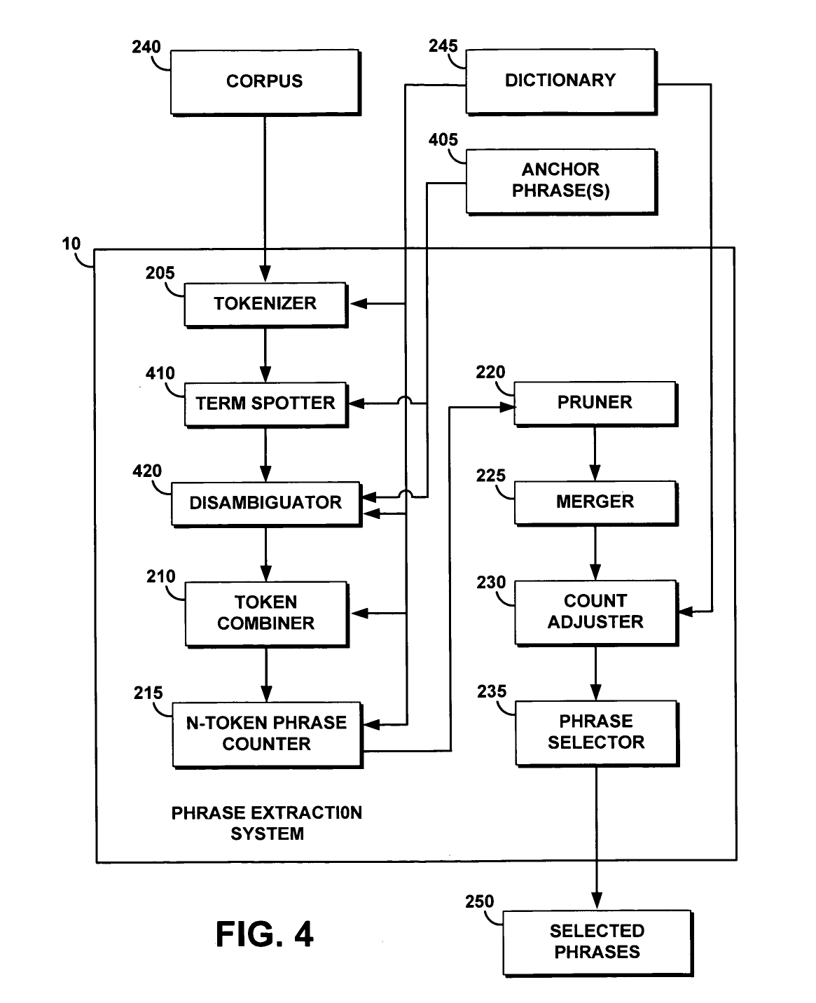

FIG. 4 illustrates a high-level hierarchy of one embodiment of system 10 in which system 10A analyzes phrases near any of a given set of anchor phrases 405. System 10A comprises tokenizer 205, a term spotter 410, a disambiguator 415, the token combiner 210, the N-token phrase counter 215, pruner 220, merger 225, count adjustor 235, and the phrase selector 235.

Input to system 10A is an anchor phrases 405, comprising user-provided “anchor phrases” around which system 10A identifies N-token phrases. The term spotter 410 identifies in the corpus 240 the anchor phrases found in the anchor phrases 405. The disambiguator 415 disambiguates references to the anchor phrases. An anchor phrase may comprise one or more tokens.

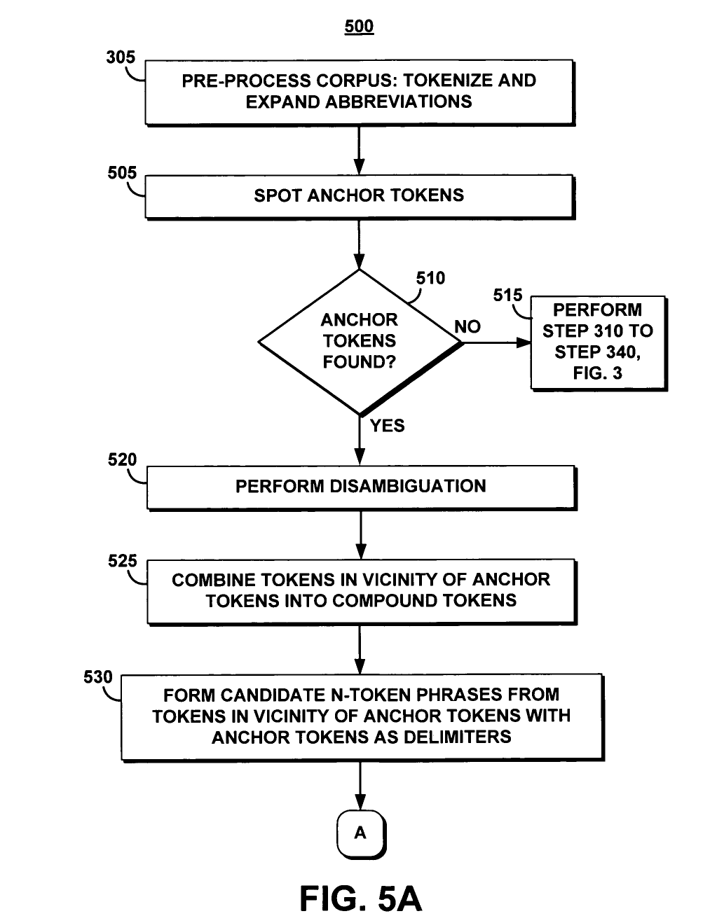

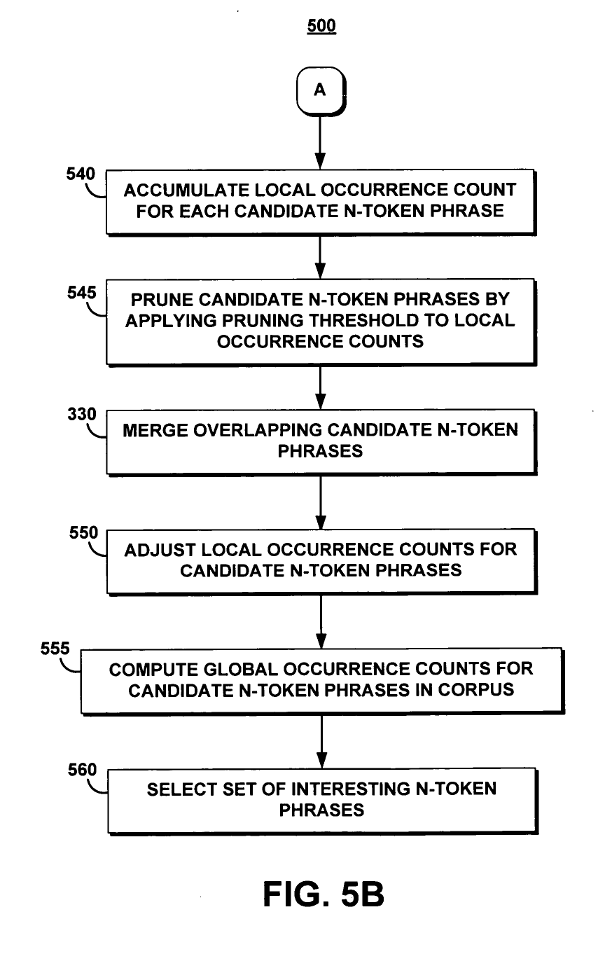

FIG. 5 (FIGS. 5A, 5B) illustrates a method 500 of system 10A in generating a set of selected phrases 250 from a corpus 240 using dictionary 245 and the anchor phrases 405 as input. System 10 preprocesses corpus 240 as previously described (step 305).

Using anchor phrases 405, the term spotter 410 spots anchor tokens representing anchor phrases in the set of tokens (step 505). Anchor phrases 405 are useful in determining, for example, public reaction to a product. Company ABC with a product named “laptop computer Q.2” wishes to determine public reaction to “laptop computer Q.2”. In this case, “company ABC” and “laptop computer Q.2” can be designated as anchor phrases. The term spotter 410 spots these anchor phrases in the set of tokens, designating the spotted tokens as anchor tokens found in anchor phrases 405. System 10 can then identify selected phrases occurring near the anchor tokens. Company ABC can use the selected phrases to determine a context in which the anchor phrase “laptop computer Q.2” or “company ABC” is used in corpus 240 and to analyze any trends or consumer attitudes regarding the anchor phrases.

If anchor tokens are found in corpus 240 (decision step 510), system 10 processes only documents comprising an occurrence of an anchor token and only the text in the documents in the vicinity of an anchor token (further referenced herein as the specified vicinity), generating a set of selected tokens. The specified vicinity is adjustable by the user and comprises: (a) a w-word window centered on the anchor token; (b) a sentence in which an anchor token is found; (c) a paragraph in which an anchor token is found; (d) a markup tag in which an anchor token is found (for a marked up input corpus), etc. If no anchor tokens are found (decision step 515), system 10 processes corpus 240 as previously described in step 310 through step 340 of FIG. 3 (as indicated in step 515).

The disambiguator 415 performs disambiguation, eliminating false tokens identified as anchor tokens (step 520). Using context and grammar rules from dictionary 245, false tokens are identified as anchor tokens by system 10 when, for example, an acronym is expanded inaccurately or a word sequence is ambiguous, requiring disambiguation by disambiguator 415. For example, an acronym ABC for company ABC may be expanded as Any Business Company. Another ABC acronym in corpus 240 may represent Allied Brotherhood of Comedians. Tokenizer 205 expands the acronym ABC as Any Business Company throughout the corpus. Through context, disambiguator 415 identifies as anchor tokens the tokens that match Any Business Company and disregards the tokens that identified Allied Brotherhood of Comedians as Any Business Company.

From the predefined list of compound phrases, the token combiner 210 identifies tokens within the specified vicinity representing a compound phrase. The token combiner 210 combines the identified tokens into a compound token and applies grammar rules from dictionary 245 (step 525). A compound token can comprise one or more tokens. Each compound token comprises compound token attributes that indicate how the compound token is to be accumulated in an N-token phrase. Compound token attributes comprise use-as-single-token and use-as-delimiter.

The N-token phrase counter 215 forms candidate N-token phrases (step 530). The N-token phrase counter 215 examines each sequence of selected tokens in the specified vicinity of the anchor token, forming token sequences up to a length of N tokens. The parameter N is a parameter adjustable by a user. A typical value for N is, for example, 5. Within each token sequence, the N-token phrase counter 215 treats each compound token as directed by the associated compound token attribute. If the compound token attribute use-as-single-token is true, the N-token phrase counter 215 considers the compound token a single token. The compound token counts as one token in the N-token phrase. If the compound token attribute use-as-delimiter is true, the N-token phrase counter 215 considers the compound token as a delimiter and does not construct N-token phrases that comprise or cross over the compound token. The N-token phrase counter 215 does not form token sequences that cross sentence, paragraph, or other context boundaries such as, for example, table cells.

The N-token phrase counter 215 considers anchor tokens as delimiters. The N-token phrase counter 215 does not form an N-token phrase that comprises an anchor token. For example, the N-token phrase counter 215 processes the following text in which “laptop Q.2” is a specified anchor phrase:

“I bought a laptop Q.2 and it works great!”

Possible N-token phrases are shown in Table 1.

TABLE 1
Possible N-token phrases for the sentence “I bought a laptop Q.2
and it works great!” in which laptop Q.2 is an anchor token.

| Beginning | | Ending |
|---|---|---|
| N-token phrase | Anchor token | N-token phrase |
| I | | |
| I bought | | |
| I bought a | | |
| | laptop Q.2 | |
| | | and |
| | | and it |
| | | and it works |
| | | and it works great |

The N-token phrase counter 215 selects candidate N-token phrases from the token sequences. The candidate N-token phrases do not start or end with a stop word as defined in the stop words list in dictionary 240. In the exemplary set of N-token phrases of Table 1, the N-token phrase counter 215 ignores “I”, and “a” from the beginning N-token phrases. The N-token phrase counter 215 ignores “and” from the ending N-token phrases. The phrase “and it” is ignored completely because the phrase begins with “and” and ends with “it”. Consequently, candidate N-token phrases for “I bought a laptop Q.2 and it works great!” are “bought”, “it works” and “it works great”. Furthermore, the candidate N-token phrases do not start with a numeric token, eliminating uninteresting or noisy text strings such as tracking numbers and product codes. System 10 maintains a table entry in a candidate N-token phrase table for each candidate N-token phrase.

The N-token phrase counter 215 accumulates a local occurrence count for each of the candidate N-token phrases found within the specified vicinity (step 540). When corpus 240 has been processed, pruner 220 applies a pruning threshold to the local occurrence counts, favoring longer phrases (step 545).

The merger 225 merges candidate N-token phrases with similar tokens into longer candidate phrases (step 330, previously described). The count adjuster 230 adjusts local occurrence counts for candidate N-token phrases that are sub-phrases or that comprise a plural or a possessive, generating an adjusted local occurrence count for candidate N-token phrases (step 550).

In addition to a local occurrence count of the candidate N-token phrases in the specified vicinity of the anchor tokens, the phrase selector 235 computes a global occurrence count for each of the candidate N-token phrases from corpus 240 (step 555). The global occurrence counts are computed by, for example, accumulating an approximate full-text count as the candidate N-token phrases are identified and processed, reprocessing corpus 240, or reprocessing documents in corpus 240 that comprise one or more anchor tokens.

The phrase selector 235 generates an approximate global occurrence count by monitoring the local occurrence count generated within the specified vicinity of the anchor phrases. When the local occurrence count exceeds a threshold, the candidate N-token phrase is designated as a global candidate N-token phrase. The phrase selector 235 starts a global occurrence count for the global candidate N-token phrase by counting occurrences of the candidate N-token phrase in the full text. Consequently, system 10 determines a local occurrence count (within the specified vicinity) and a global occurrence count (over corpus 240).

The phrase selector 235 computes a score for each of the candidate N-token phrases as:
f=[local occurrence count/global occurrence count].
This score is similar to a tfidf value. The phrase selector 235 orders the candidate N-token phrases according to score. The phrase selector 235 selects for output as selected phrases 250 those candidate N-token phrases with the k highest score values (step 560).

In one embodiment, system 10 analyzes a time-varying corpus such as an on-going web crawl in which new or modified documents are available on a continual basis. The phrase selector 235 computes occurrence counts over the full text of new documents in corpus 240 in addition to the text in the specified vicinity of the anchor tokens, providing a local occurrence count and a global occurrence count for each candidate N-token phrase. The phrase selector 235 computes f, the [local occurrence count/global occurrence count] score for each candidate N-token phrase. The phrase selector 235 computes fₙ, an average of the [local occurrence count/global occurrence count] score for the candidate N-token phrase over the preceding n intervals. If fₙ=0, the phrase selector 235 flags the candidate N-token phrase as a new phrase. If fₙ≠0, the phrase selector 235 computes a relative occurrence count as f/fₙ.

The phrase selector 235 orders the candidate N-token phrases according to the relative count f/fₙ. The phrase selector 235 selects for output as the selected phrases 250 those candidate N-token phrases with the k highest values of relative count (step 545).

System 10 maintains historical counts to use in processing candidate N-token phrases in a time-varying corpus. Each time a candidate N-token phrase is processed, system 10 saves the current value for f/fₙ for all applicable candidate N-token phrases for use in future computations. Previously saved values for f/fₙ are discarded after n intervals.

It is to be understood that the specific embodiments of the invention that have been described are merely illustrative of certain applications of the principle of the present invention. Numerous modifications may be made to the system and method for automatically extracting interesting phrases in a large dynamic corpus described herein without departing from the spirit and scope of the present invention.

What is claimed is:

1. A method of automatically extracting a plurality of interesting phrases in a corpus, comprising:
generating a plurality of tokens by tokenizing the corpus and expanding abbreviations as directed by a dictionary,
combining the tokens into compound tokens as directed by the dictionary;
forming candidate N-token phrases from the tokens and the compound tokens;
accumulating an occurrence count for at least some of the candidate N-token phrases;
pruning the candidate N-token phrases by applying a pruning threshold;
merging overlapping candidate N-token phrases;
adjusting an occurrence count of each of the candidate N-token phrases to account for any one or more of a sub-phrase, a plural, or a possessive; and
ordering the candidate N-token phrases according to a score, and selecting the interesting phrases as the highest ranking candidate N-token phrases.

2. The method of claim 1, wherein the corpus is static.

3. The method of claim 2, wherein the score includes an occurrence count of the candidate N-token phrases.

4. The method of claim 1, wherein the corpus is time-variable.

5. The method of claim 4, wherein the score includes an occurrence count of the candidate N-token phrases, which is determined over preceding n intervals of time.

6. The method of claim 1, further comprising:
selecting anchor phrases; and
identifying anchor tokens corresponding to the selected anchor phrases.

7. The method of claim 6, further comprising disambiguating the anchor tokens by identifying desired anchor tokens through context.

8. The method of claim 6, wherein forming the candidate N-token phrases comprising forming the candidate N-token phrases within a predetermined vicinity of an anchor phrase using anchor tokens as delimiter.

9. The method of claim 8, wherein the vicinity of the anchor phrase comprises a predetermined window.

10. The method of claim 8, wherein the vicinity of the anchor phrase comprises a sentence.

11. The method of claim 8, wherein the vicinity of the anchor phrase comprises a paragraph.

12. The method of claim 8, wherein the vicinity of the anchor phrase comprises a markup tag.

13. The method of claim 8, wherein accumulating the occurrence count comprises accumulating a local occurrence count for each candidate N-token phrase occurring within the vicinity of the anchor token.

14. The method of claim 13, further comprising computing a global occurrence count for candidate N-token phrases over the corpus.

15. The method of claim 14, wherein the score comprises the local occurrence count and the global occurrence count.

16. A computer program product comprising a computer usable medium having computer usable program codes for automatically extracting a plurality of interesting phrases in a corpus, the computer program product comprising:
computer usable program code for generating a plurality of tokens by tokenizing the corpus and expanding abbreviations as directed by a dictionary,
computer usable program code for combining the tokens into compound tokens as directed by the dictionary;
computer usable program code for forming candidate N-token phrases from the tokens and the compound tokens;
computer usable program code for accumulating an occurrence count for at least some of the candidate N-token phrases;
computer usable program code for pruning the candidate N-token phrases by applying a pruning threshold;
computer usable program code for merging overlapping candidate N-token phrases;
computer usable program code for adjusting an occurrence count of each of the candidate N-token phrases to account for any one or more of a sub-phrase, a plural, or a possessive; and
computer usable program code for ordering the candidate N-token phrases according to a score, and selecting the interesting phrases as the highest ranking candidate N-token phrases.

17. The computer program product of claim 16, wherein the corpus is static.

18. The computer program product of claim 17, wherein the score includes an occurrence count of the candidate N-token phrases.

19. The computer program product of claim 16, wherein the corpus is time-variable.

20. A system for automatically extracting a plurality of interesting phrases in a corpus, comprising:
a tokenizer for generating a plurality of tokens by tokenizing the corpus and expanding abbreviations as directed by a dictionary,
a token combiner for combining the tokens into compound tokens as directed by the dictionary;
an token phrase counter for forming candidate N-token phrases from the tokens and the compound tokens, and for accumulating an occurrence count for at least some of the candidate N-token phrases;
a pruner for pruning the candidate N-token phrases by applying a pruning threshold;
a merger for merging overlapping candidate N-token phrases;
a count adjuster for adjusting an occurrence count of each of the candidate N-token phrases to account for any one or more of a sub-phrase, a plural, or a possessive; and
a phrase selector ordering the candidate N-token phrases according to a score, and for selecting the interesting phrases as the highest ranking candidate N-token phrases.
